(19) United States
(12) Patent Application Publication
(10) Pub. No.: US 2003/0193098 A1
(43) Pub. Date: Oct. 16, 2003

(54) Humidifier with removable wicking element

(75) Inventors: Brian L. LeMahieu, Sheboygan, WI (US); Joseph M. Hand, Sheboygan Falls, WI (US); John W. Seaman, Sheboygan Falls, WI (US)

Correspondence Address: David R. Price, Michael Best & Friedrich LLP, 100 East Wisconsin Avenue, Milwaukee, WI, 53202-4108, US

(73) Assignee: Bemis Manufacturing Company, Sheboygan Falls, WI

(21) Appl. No.: 10/122,564

(22) Filed: Apr. 15, 2002

(51) Int. Cl. B01F 3/04

(52) U.S. Cl. 261/107; 261/DIG. 41

(57) ABSTRACT

A humidifier includes a housing assembly which defines a water reservoir, an air inlet, and air outlet, and an opening. The humidifier also includes a wicking element that is insertable and removable through the opening defined by the housing assembly. A blower for causing air to flow through the air inlet, through the wicking element, and through the air outlet is also included in the humidifier. Furthermore, when the wicking element is inserted into the humidifier, it substantially closes the opening it was inserted through and is in fluid communication with the water in the water reservoir.

### BACKGROUND OF THE INVENTION

The present invention relates to humidifiers and, more particularly to humidifiers including a removable and insertable wicking element.

The effectiveness of a wicking element is partially dependent upon the minerals in the water, and if the water is not treated, the bacteria growth in the wicking medium. When a wicking element becomes ineffective (due to bacteria growth or minerals in the water), it is best to change the wicking element at the earliest opportunity. This requires frequent inspections of the wicking element by the user.

Often times, wicking elements are not examined frequently because the removal or inspection of such a wicking element requires the humidifier to be disassembled or a portion of the housing to be removed. This in turn requires the humidifier to be reassembled when the wicking element is inserted. Since assembling and disassembling the humidifier is not a convenient method for accessing the wicking element, wicking elements often become neglected. When wicking elements are not inspected regularly and frequently, the user is not aware when the wicking element becomes ineffective.

### SUMMARY OF THE INVENTION

In one embodiment, the invention provides a humidifier including an easily removable and insertable wicking element. Specifically, the humidifier requires no disassembly prior to removing the wicking element and requires no assembly after inserting the wicking element. The humidifier includes an opening through which the wicking element is inserted and removed. When the wicking element is inserted through the opening, it substantially closes the opening.

In another embodiment, the humidifier provides a path that is free from obstructions for the removal and insertion of the wicking element. The wicking element also includes a handle to aid in the removal and insertion.

As is apparent from the above, it is an advantage of the invention to provide a humidifier with an easily accessible wicking element. Other features and advantages of the invention will become apparent by consideration of the detailed description and accompanying drawings.

### BRIEF DESCRIPTION OF THE DRAWINGS

In the drawings:

FIG. 1 is an exploded perspective view of a humidifier embodying the invention.

FIG. 2 is a cross-sectional view of the humidifier.

FIG. 3 is a partial cross-sectional view of the humidifier illustrating the insertion and removal path of a wicking element included in the humidifier.

FIG. 4 is a partial, exploded cross-sectional view of the humidifier.

FIG. 5 is a view taken along line 5-5 in FIG. 4.

FIG. 6 is a view taken along line 6-6 in FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

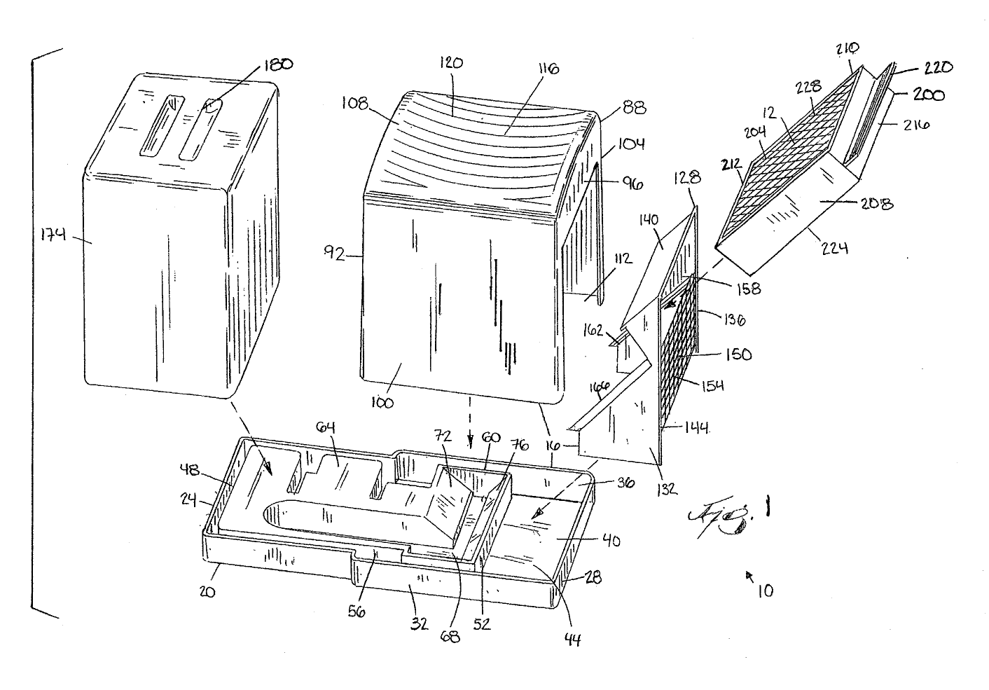

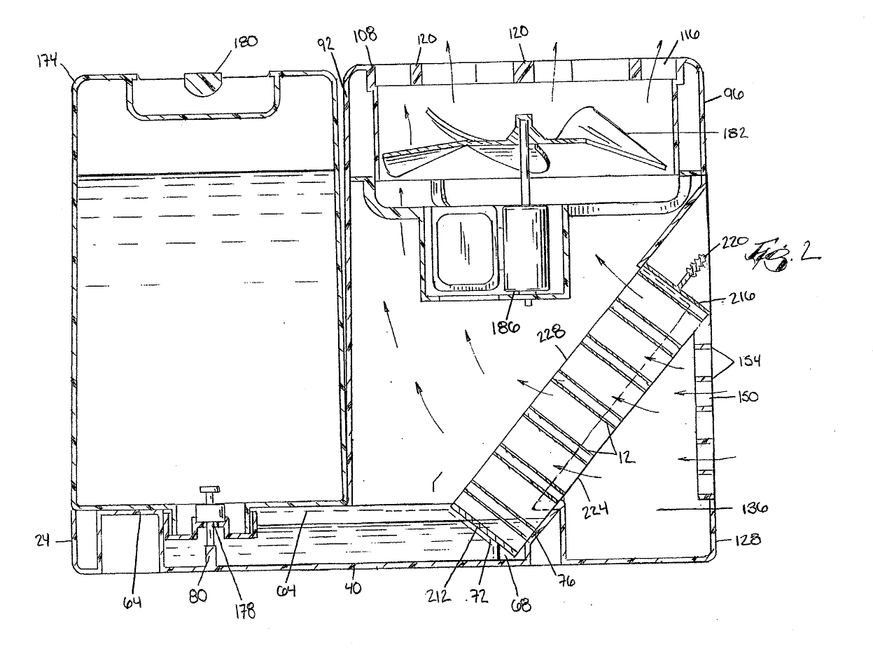

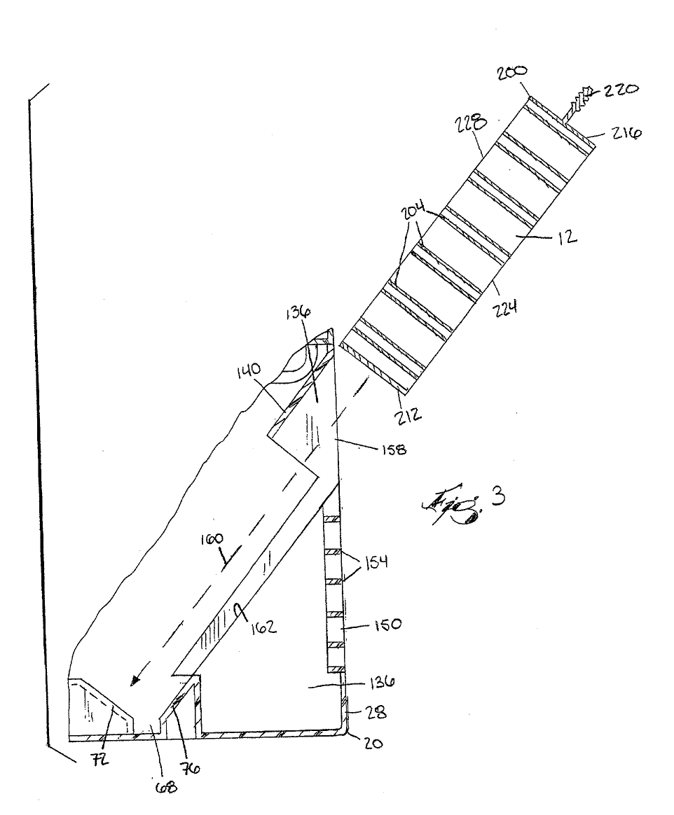

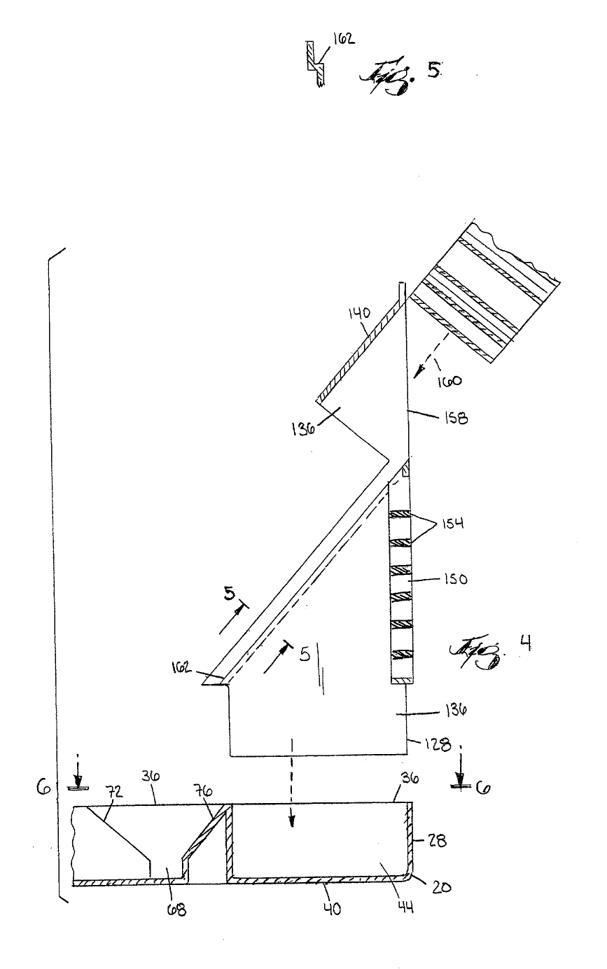

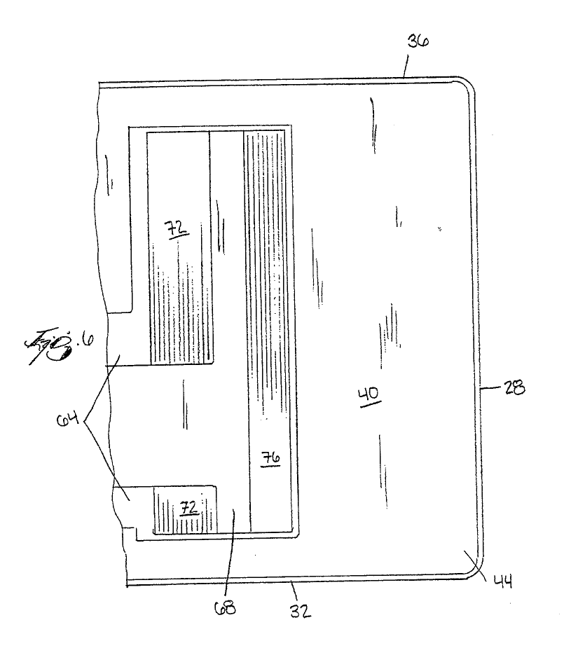

A humidifier 10 embodying the invention is illustrated in FIGS. 1-6. The humidifier 10 includes an easily-accessible, removable wicking element 12. The humidifier 10 also includes a housing assembly or housing 16, which substantially covers the wicking element 12 when the element 12 is positioned in the humidifier 10. The housing 16 is preferably injection-molded out of plastic, as is well known in the art. As illustrated in FIG. 1, the housing 16 includes a lower housing portion or base 20 having opposite left and right walls 24, 28, and front, rear, and bottom walls 32, 36, 40 extending between the left and right walls 24, 28. The walls 24, 28, 32, 36, 40 define recess 44. The base 20 further includes opposite inner left and inner right walls 48, 52, and inner front and inner rear walls 56, 60 extending between the inner left and inner right walls 48, 52. The inner walls 48, 52, 56, 60, surrounded by recess 44, define platform 64, which defines the water reservoir 68. Platform 64 also includes two generally planar, slanted surfaces 72, 76. The slanted surface 72 is positioned at an angle of approximately 40° from horizontal. The slanted surface 76 is positioned at an angle of approximately 50° from horizontal and is approximately perpendicular to the slanted surface 72. A tank valve opening peg or projection 80 (see FIG. 2) that extends vertically is formed on the bottom wall 40 of the water reservoir 68.

The housing 16 further includes a main housing member 88 which rests on the base 20. The main housing member 88 includes opposite left and right outer walls 92, 96 and front, rear, and top outer walls 100, 104, 108 extending between the left and right outer walls 92, 96. The right outer wall 96 of the main housing member 88 defines an opening 112. The top outer wall 108 of the main housing member 88 defines an air outlet 116, which is covered by an outlet grille 120.

The housing 16 further includes a second housing member 128 that substantially closes opening 112 in the main housing member 88 when the humidifier 10 is assembled. Preferably, the housing member 128 is permanently secured to the housing member 88, such as with an adhesive, before the humidifier 10 is sold. The two members 88 and 128 then form a single upper housing piece removably mounted on the base 20. The housing members 88 and 128 are made separately and then fixed together because this greatly simplifies injection molding. If the members 88 and 128 were molded as a single unit, the injection molding process would be much more complicated, as can be appreciated by those skilled in the art.

The second housing member 128 includes opposite front and rear walls 132, 136 and a top wall 140 extending between the front and rear walls 132, 136. In the embodiment shown, the top wall 140 is positioned at an angle of approximately 50° from horizontal. Also extending between the front and rear walls 132, 136 of the second housing member 128 is a right outer wall 144. The right outer wall 144 defines an air inlet 150, which is covered by an inlet grille 154. The right outer wall 144 further defines an opening or slot 158. In the embodiment shown, the slot 158 is substantially rectangular. The slot 158 defines a path 160 that is free from obstructions. The wicking element 12 is inserted into and removed from the humidifier 10 through slot 158 and along path 160, as will be more fully discussed below. The second housing member 128 also includes two parallel rails or surfaces 162, 166 extending from the rear and front walls 136, 132, respectively. The rails 162, 166 are substantially coplanar with the second generally planar surface 76 when the humidifier 10 is assembled.

In alternative embodiments of the invention, the housing assembly 16 can include fewer or more housing members, and the housing members can be of varying shape and size.

The humidifier 10 also includes a water tank 174, which rests on the base 20, covering in part the water reservoir 68. The water tank 174 includes a standard outlet valve 178 through which water can exit the tank 174 into the water reservoir 68. The water tank 174 further includes a handle 180.

A blower or fan 182 is mounted in the housing 16, as is well known in the art. As illustrated in FIG. 2, the fan 182 is below the air outlet 116 and above the wicking element 12. The power cable and controls needed to run the motor are not shown for simplicity, but are also well known in the art.

The wicking element 12 is of a design known in the art that is substantially a rectangular parallelepiped and includes a plastic structural frame 200 and a pleated paper wicking medium 204. Any other compatible wicking element designs and other frame and wicking medium materials known in the art may be used. The frame 200 includes opposite first and second side walls 208, 210 and opposite base and top walls 212, 216 extending between the first and second side walls 208, 210. The top wall 216 of the frame 200 includes a handle 220 for aid in the removal and insertion of the wicking element 12. During operation, the wicking element 12 is positioned within the humidifier 10 such that the first planar surface 72, the second planar surface 76 and rails 162 and 166 each support a portion of the wicking element 12 and a portion of the wicking element 12 extends into the water reservoir 68. A bottom side 224 of the wicking element 12 generally faces the air inlet 150 and the water in the water reservoir 68, while a top side 228 that is generally parallel to the bottom side 224 generally faces the fan 182 and air outlet 116.

In operation, the water tank 174 is filled and placed on the base 20 of the humidifier 10. The tank valve opening peg 80 causes the outlet valve 178 to open, thus allowing water to flow into the water reservoir 68. As is known in the art, the water rises to the level of the valve 178. Water in the reservoir 68 wicks up the medium 204 of the wicking element 12, causing the wicking medium 204 to become saturated with water. When the humidity in the vicinity of the humidifier 10 is detected by a humidistat (not shown) as being below the humidistat setpoint, the motor 186 and thus the fan 182 are caused to run. An air flow is created through the humidifier 10, as indicated by the arrows in FIG. 2.

Air flows through the air inlet grille 154 and passes through the wicking element 12. The water that has saturated the wicking medium 204 evaporates and becomes entrained in the air flow. Water continues to saturate the wicking medium 204, by the same wicking action, resulting in a continuous flow of water into the wicking element 12 during operation. As water is absorbed into the wicking element 12 from the water reservoir 68, the water level of the reservoir 68 drops. The water is replaced automatically by a flow of water out of the water tank 174. The humid air, then, leaves the wicking element 12, passes the fan 182, and then exits the humidifier 10 through the outlet grille 120 in the top outer wall 104 of the main housing member 88. Once the humidity in the vicinity of the humidifier 10 as detected by the humidistat rises above the humidistat setpoint, the motor 186 and fan 182 are turned off and air flow through the humidifier 10 ceases.

As stated previously, the wicking element 12 is inserted into humidifier 10 and removed from humidifier 10 along path 160. Upon insertion, the base wall 212 of wick frame 200 passes through slot 158. The rails 162, 166 of the housing 16 guide the wick frame 200 as it is inserted. The second planar surface 76 of base 20 further guides the wick frame 200 as it is inserted until the base wall 212 contacts the first planar surface 72 of base 20. This contact prevents the wick frame 200 from further proceeding along path 160. After insertion, the wicking element 12 is positioned within the humidifier 10 such that the first planar surface 12, the second planar surface 76 and the rails 162, 166 each support a portion of the wick frame 200 while a portion of the wicking element 12 extends into the water reservoir 68. Furthermore, when the wicking element 12 is inserted into the humidifier 10, the top wall 216 of the wick frame 200 substantially closes the slot 158. The handle 220 enables a user to remove the wick frame 200 by simply pulling the frame 200 by the handle 220 along the path 160 until the base wall 212 of the wick frame 200 passes through slot 158. This design enables a fast and easy replacement procedure without disassembling the humidifier (e.g. removing a wall or cover).

Various features and advantages of the invention are set forth in the following claims.

What is claimed is:

1. A humidifier comprising:
a housing defining a water reservoir and having an outer wall, the outer wall defining an air inlet, an air outlet and an opening;
a wicking element insertable and removable through the opening, and when inserted into the opening, the wicking element substantially closes the opening and is in fluid communication with the water in the reservoir; and
a blower for causing air flow through the air inlet, through the wicking element, and through the air outlet.

2. The humidifier of claim 1, wherein the housing includes a lower housing portion defining the water reservoir and an upper housing portion defining the air inlet, air outlet, and opening.

3. The humidifier of claim 2, wherein the upper housing portion further comprises:
a main member defining the air outlet; and
a separate second member defining the air inlet and the opening.

4. The humidifier of claim 1, wherein the housing includes at least two rails, wherein the rails guide the wicking element upon insertion and support the wicking element when inserted.

5. The humidifier of claim 1, wherein the opening is a rectangular slot.

6. The humidifier of claim 1, wherein the wicking element is removed and inserted along a path that is not vertical.

7. The humidifier of claim 6, wherein the wicking element is removed and inserted along a path that is not horizontal.

8. The humidifier of claim 7, wherein the wicking element is removed and inserted along a path at an angle of approximately fifty degrees from horizontal.

9. The humidifier of claim 2, wherein the base includes a generally planar surface that supports the wicking element.

10. The humidifier of claim 9, wherein the base includes a second planar surface that supports the wicking element and that is substantially perpendicular to the first generally planar surface.

11. The humidifier of claim 10, wherein the housing includes at least two rails coplanar with the second planar surface, wherein the rails guide the wicking element upon insertion and that support the wicking element when the wicking element is inserted.

12. The humidifier of claim 10, wherein the first and second planar surfaces are not horizontal.

13. The humidifier of claim 11, wherein the first planar surface is positioned at an angle of approximately 40 degrees from horizontal and the second planar surface is positioned at an angle of approximately 50 degrees from horizontal.

14. The humidifier of claim 1, wherein the air inlet is covered by a grille.

15. The humidifier of claim 1, wherein the humidifier further comprises a handle coupled to the wicking element to assist in removal and insertion of the wicking element.

16. The humidifier of claim 2, wherein the wicking element includes:
a bottom side generally facing the water reservoir and air inlet when the wicking element is inserted; and
a top side generally parallel to the bottom side and generally facing the blower and air outlet when the wicking element is inserted.

17. The humidifier of claim 2, wherein the wicking element includes two generally parallel sides, a first side generally facing the air inlet and a second side generally facing the air outlet.

18. A humidifier comprising:
a base defining a water reservoir;
a housing member engageable to the base, wherein the housing member defines an air inlet, an air outlet and a slot;
a wicking element insertable and removable through the slot, and when inserted into the slot, the wicking element is in fluid communication with the water reservoir, and wherein the slot provides a path free from obstructions for the wicking element to be inserted and removed along; and
a blower for causing air flow through the air inlet, through the wicking element, and through the air outlet.

19. The humidifier of claim 18, wherein the humidifier further includes a handle coupled to the wicking element to assist in removal and insertion of the wicking element.

20. The humidifier of claim 18, wherein the path is not a vertical path and not a horizontal path.

21. The humidifier of claim 20, wherein the path is approximately 50 degrees from horizontal.

22. The humidifier of claim 18, wherein the housing member further comprises:
a main member defining the air outlet; and
a separate second member defining the air inlet and the opening.

23. The humidifier of claim 18, wherein the housing member includes two rails, wherein the rails guide the wicking element upon insertion and support the wicking element when inserted.

24. The humidifier of claim 18, wherein the base includes a generally planar surface that supports the wicking element.

25. The humidifier of claim 24, wherein the base further includes a second planar surface that supports the wicking element and that is substantially perpendicular to the first generally planar surface.

26. The humidifier of claim 25, wherein the housing member includes two rails coplanar with the second planar surface, wherein the rails guide the wicking element upon insertion and that support the wicking element when the wicking element is inserted.

27. The humidifier of claim 26, wherein the first planar surface is positioned at an angle of approximately 40 degrees from horizontal and the second planar surface is positioned at an angle of approximately 50 degrees from horizontal.

28. The humidifier of claim 18, wherein the air inlet is covered by a grille.

29. The humidifier of claim 18, wherein the air outlet is covered by a grille.

30. The humidifier of claim 18, wherein the wicking element substantially closes the slot when the wicking element is inserted into the slot.

31. The humidifier of claim 18, wherein the slot is substantially rectangular.

32. A humidifier comprising:
a housing defining a water reservoir and having two rails and an outer wall, the outer wall defining an air inlet, and air outlet and an opening;
a wicking element insertable and removable through the opening, and when inserted into the opening, the wicking element substantially closes the opening and is in fluid communication with the water in the reservoir, and wherein the opening provides a path free from obstructions for the wicking element to be inserted and removed;
a blower for causing air flow through the air inlet, through the wicking element, and through the air outlet; and
wherein the two rails are coplanar with the path, guide the wicking element upon insertion, and support the wicking element when the element is inserted.

33. The humidifier of claim 1, wherein the path provided by the opening is not vertical and not horizontal.
